(19) United States
(12) Patent Application Publication
(10) Pub. No.: US 2025/0238481 A1
(43) Pub. Date: Jul. 24, 2025

(54) MATRIX INDEX INFORMATION GENERATION METHOD, AND MATRIX PROCESSING METHOD USING MATRIX INDEX INFORMATION

(71) Applicant: INDUSTRY ACADEMY COOPERATION FOUNDATION OF SEJONG UNIVERSITY, Seoul (KR)

(72) Inventors: Gi-Ho PARK, Seoul (KR); Chi Won HAN, Seoul (KR)

(21) Appl. No.: 18/986,511

(22) Filed: Dec. 18, 2024

Related U.S. Application Data
(63) Continuation of application No. PCT/KR2023/019498, filed on Nov. 30, 2023.

(30) Foreign Application Priority Data
Dec. 13, 2022 (KR) 10-2022-0173282
Feb. 15, 2023 (KR) 10-2023-0019910

(51) Int. Cl. G06F 17/16

(52) U.S. Cl. CPC G06F 17/16

(57) ABSTRACT

Disclosed are a method for generating matrix index information for a target matrix including a sparse matrix, and a method for processing a matrix by using matrix index information. The disclosed matrix index information generation method comprises the steps of: identifying the presence or absence of a non-zero element in each row or column of a target matrix, and generating a first bitstring including information on the presence or absence of the non-zero element in each row or column of the target matrix.

### CROSS-REFERENCE TO RELATED APPLICATIONS

This application is a bypass continuation of pending PCT International Application No. PCT/KR2023/019498, which was filed on Nov. 30, 2023, and which claims priority to and the benefit of Korean Patent Application No. 10-2022-0173282, which was filed in the Korean Intellectual Property Office on Dec. 13, 2022, and Korean Patent Application No. 10-2023-0019910, which was filed in the Korean Intellectual Property Office on Feb. 15, 2023, the disclosure of which are incorporated herein by reference in its entirety.

### TECHNICAL FIELD

The present disclosure relates to a method of generating matrix index information and a method of processing a matrix using matrix index information, and more particularly, to a method of generating index information of a target matrix including a sparse matrix and a method of processing a matrix using index information of the matrix.

### BACKGROUND ART

With the recent development of neural network models, such as a convolutional neural network (CNN) utilized in areas of service such as image recognition and the like, the depth of layers that neural network models need to process has been increasing. This factor has led to an increase in the number of parameters, such as weight matrices, of a neural network model, making high memory overhead a significant issue.

To solve this problem, studies have been carried out on a matrix indexing method for efficiently performing computation on a sparse matrix using the fact that a pruning technique which is performed to solve the overfitting problem of a neural network model makes a weight matrix a sparse matrix.

As a method of indexing a sparse matrix, compressed sparse row (CSR) is frequently utilized. Sparse matrix indexing methods like CSR have disadvantages of requiring computation to determine index sizes and positions when applied to each weight matrix, and significant overhead for the representation of a matrix with low sparsity, that is, a matrix with a small number of non-zero elements.

### DISCLOSURE

### Technical Problem

The present disclosure is directed to providing a method of generating matrix index information in which the size of matrix index information is kept constant.

The present disclosure is also directed to providing a method of generating matrix index information in which the number of memory accesses for matrix computation is reduced.

The present disclosure is also directed to providing a method and device for loading information about a target matrix from a memory using matrix index information about the target matrix and processing the matrix.

### Technical Solution

One aspect of the present disclosure provides a method of generating matrix index information, the method including identifying presence or absence of a non-zero element in each row or column of a target matrix and generating a first bitstring including information on the presence or absence of the non-zero element in each row or column of the target matrix.

Another aspect of the present disclosure provides a method of generating matrix index information, the method including identifying a number of non-zero elements in each row or column of a target matrix and generating a first bitstring including information on the number of non-zero elements in each row or column of the target matrix.

Another aspect of the present disclosure provides a method of processing a matrix using matrix index information, the method including loading a non-zero element of a first target matrix from a memory using matrix index information of the first target matrix and transmitting the loaded data to processing elements. The matrix index information includes information on presence or absence of the non-zero element in each row or column of the first target matrix.

Another aspect of the present disclosure provides a method of processing a matrix using matrix index information, the method including loading non-zero elements of a first target matrix from a memory using matrix index information of the first target matrix and transmitting the loaded data to processing elements. The matrix index information includes number information of non-zero elements in each row or column of the first target matrix.

### Advantageous Effects

According to an embodiment of the present disclosure, even when the sparsity of a matrix is reduced, the size of matrix index information can be kept constant, and thus it is possible to reduce memory usage in an environment in which a matrix with low sparsity is used.

Also, according to an embodiment of the present disclosure, matrix index information can be used to load a non-zero element through selective memory access to a row or column of a target matrix including the non-zero element, and thus it is possible to reduce the number of memory accesses.

### DESCRIPTION OF DRAWINGS

FIG. 1 is a diagram illustrating compressed sparse row (CSR) which is a matrix indexing method.

FIG. 2 is a diagram illustrating a method of generating matrix index information according to an embodiment of the present disclosure.

FIG. 3 is a diagram illustrating matrix index information according to the embodiment of the present disclosure.

FIG. 4 is a diagram illustrating a method of generating matrix index information according to another embodiment of the present disclosure.

FIG. 5 is a diagram illustrating matrix index information according to the other embodiment of the present disclosure.

FIG. 6 is a diagram illustrating the size of matrix index information according to the embodiment of the present disclosure.

FIG. 7 is a diagram illustrating a device for processing a matrix using matrix index information according to the embodiment of the present disclosure.

FIG. 8 is a diagram illustrating a method of processing a matrix using matrix index information according to the embodiment of the present disclosure.

FIG. 9 is a diagram showing memory storage data according to the embodiment of the present disclosure.

FIG. 10 is a diagram showing memory storage data according to the other embodiment of the present disclosure.

### MODES OF THE INVENTION

Since the present disclosure can be variously modified and have several embodiments, specific embodiments will be illustrated in the drawings and described in detail. However, this is not intended to limit the present disclosure to the specific embodiments, and it should be understood that the present disclosure includes all modifications, equivalents, and substitutions within the spirit and technical scope of the present disclosure. In describing each drawing, like reference numerals are used for like components.

Hereinafter, embodiments of the present disclosure will be described in detail with reference to the accompanying drawings.

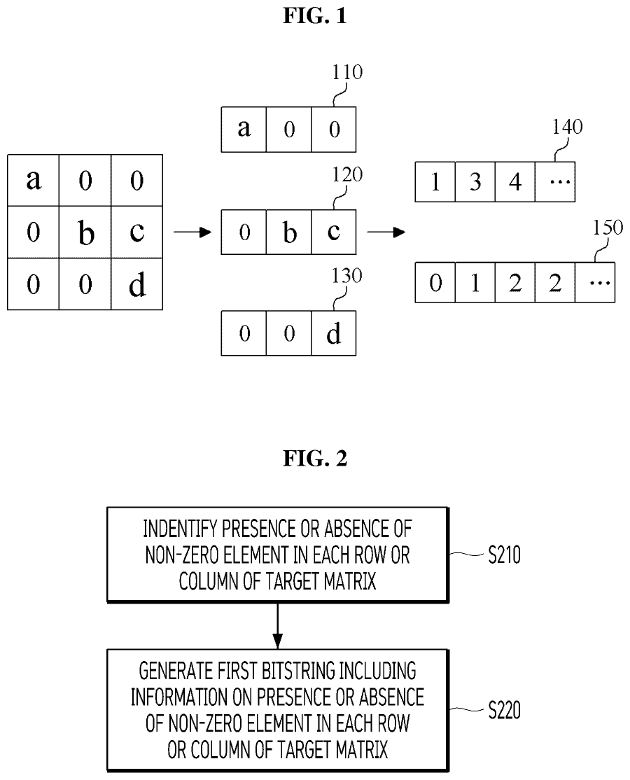

FIG. 1 is a diagram illustrating compressed sparse row (CSR) which is a matrix indexing method.

According to CRS, indexing is performed for each row of a matrix. As shown in FIG. 1, when a 3×3 target matrix 100 including 0 in addition to non-zero elements a, b, c, and d is given, according to CSR, each of the three rows is indexed to generate index information of rows and columns. The index information of rows includes cumulative information of the number of non-zero elements in each row, and the index information of columns includes position information of a non-zero element in each row.

There is one non-zero element “a” in a first row 110, and there are two non-zero elements “b” and “c” in a second row 120. Also, there is one non-zero element “d” in a third row 130. Therefore, index information 140 of rows includes an index of 1 corresponding to the number of non-zero elements in the first row 110, an index of 3 corresponding to the accumulated value of the number of non-zero elements in the first row 110 and the number of non-zero elements in the second row 120, and an index of 4 corresponding to a value calculated by adding the accumulated value of the number of non-zero elements in the first and second rows 110 and 120 and the number of non-zero elements in the third row 130.

In the first row 110, the non-zero element “a” is positioned in the first column, and in the second row 120, the non-zero elements “b” and “c” are positioned in the second and third columns. Lastly, in the third row 130, the non-zero element “d” is positioned in the third column. Therefore, index information 150 of columns includes an index of 0 corresponding to the position of the first column in the first row 110, indices of 1 and 2 corresponding to the positions of the second and third columns in the second row 120, and finally an index of 2 corresponding to the position of the third column in the third row 130.

Since CSR is a matrix indexing method for very sparse matrices, matrix index information increases in size when the sparsity of a target matrix is low, that is, when there are a high number of non-zero elements in the target matrix. Also, CSR requires at least as many memory accesses to index information as the number of rows in a target matrix.

Accordingly, the present disclosure proposes a method of generating the matrix index information in which the size of matrix index information can be kept constant even when the sparsity of a target matrix lowers, and the number of memory accesses for acquiring target matrix information can be reduced. In addition, the present disclosure proposes a method of processing a matrix using the matrix index information.

According to an embodiment of the present disclosure, the matrix index information is generated to include information about whether there is a non-zero element in each row or column of a target matrix or information about the number of non-zero elements in each row or column. Therefore, the size of matrix index information according to an embodiment of the present disclosure only depends on the size of a target matrix and does not depend on the sparsity of the target matrix. Consequently, according to an embodiment of the present disclosure, even when the sparsity of a target matrix lowers, the size of matrix index information can be kept constant.

Also, according to an embodiment of the present disclosure, matrix computation can be performed through selective memory access to a row or column including a non-zero element, which can reduce the number of memory accesses.

A method of generating the matrix index information and a method of processing a matrix using the matrix index information according to an embodiment of the present disclosure can be performed by a device for processing a matrix. For example, the methods can be performed by a computational semiconductor chip, such as a processor, a deep learning accelerator, or the like, or a computing device that includes a computational semiconductor chip and a memory.

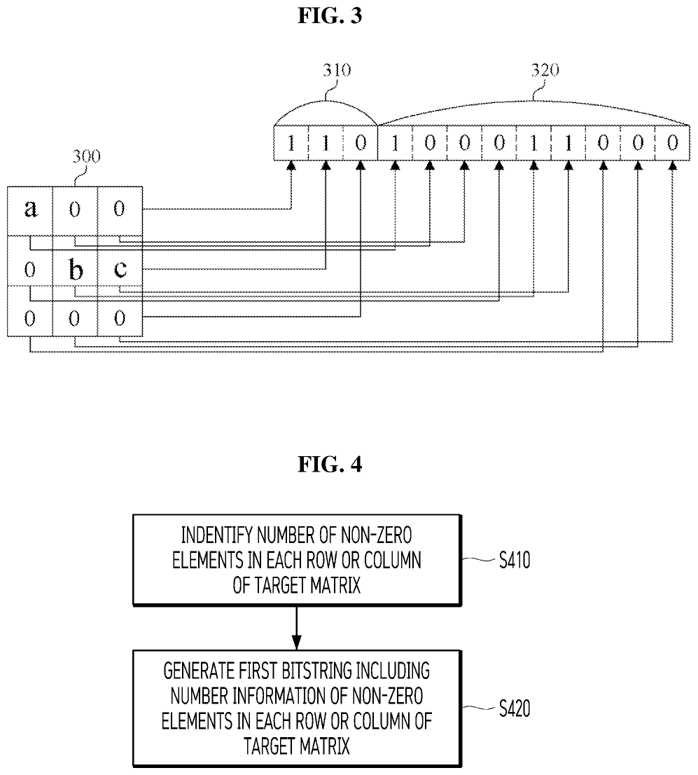

FIG. 2 is a diagram illustrating a method of generating matrix index information according to an embodiment of the present disclosure, and FIG. 3 is a diagram illustrating matrix index information according to the embodiment of the present disclosure.

Referring to FIG. 2, a device for processing a matrix according to an embodiment of the present disclosure identifies the presence or absence of a non-zero element in each row or column of a target matrix (S210) and generates a first bitstring including information on the presence or absence of a non-zero element in each row or column of the target matrix (S220). In other words, the first bitstring includes information about whether there is a non-zero element in each row or column of the target matrix.

As an embodiment, the target matrix may be a weight matrix including weights of an artificial neural network, and the first bitstring corresponds to matrix index information.

The first bitstring includes bits corresponding to each of rows or columns of the target matrix. In the first bitstring, a bit value corresponding to a row or column including a non-zero element and a bit value corresponding to a row or column including no non-zero element may be different values. For example, a bit value corresponding to a row or column including a non-zero element may be 1, and a bit value corresponding to a row or column including no non-zero element may be 0.

As shown in FIG. 3, when a target matrix 300 is a 3×3 matrix, a first bitstring 310 may include three bits. In FIG. 3, a non-zero element “a” is included in the first row of the target matrix 300, and two non-zero elements “b” and “c” are included in the second row. Accordingly, a device for processing a matrix may generate the first bitstring 310 in which a first bit value corresponding to the first row is 1, a second bit value corresponding to the second row is 1, and a third bit value corresponding to the third row is 0.

According to an embodiment, the device for processing a matrix may additionally generate a second bitstring including position information of the non-zero elements in the target matrix. In this case, the matrix index information may include first and second bitstrings. According to an embodiment, the second bitstring may be generated in parallel with the first bitstring or after the first bitstring.

The second bitstring includes bits corresponding to the positions of elements in the target matrix, and in the second bitstring, a bit value corresponding to the positions of zero elements and a bit value corresponding to the positions of the non-zero elements in the target matrix may be different values. For example, a bit value corresponding to the positions of zero elements may be 0, and a bit value corresponding to the positions of the non-zero elements may be 1.

As shown in FIG. 3, when the target matrix 300 includes nine elements, the second bitstring includes nine bits. In FIG. 3, a first bit value corresponding to the position of the non-zero element “a” in the first row and the first column of the target matrix 300, a second bit value corresponding to the position of the non-zero element “b” in the second row and the second column, and a third bit value corresponding to the position of the non-zero element “c” in the second row and the third column may be determined to be 1. Also, six other bit values corresponding to the positions of zero elements may be determined to be 0.

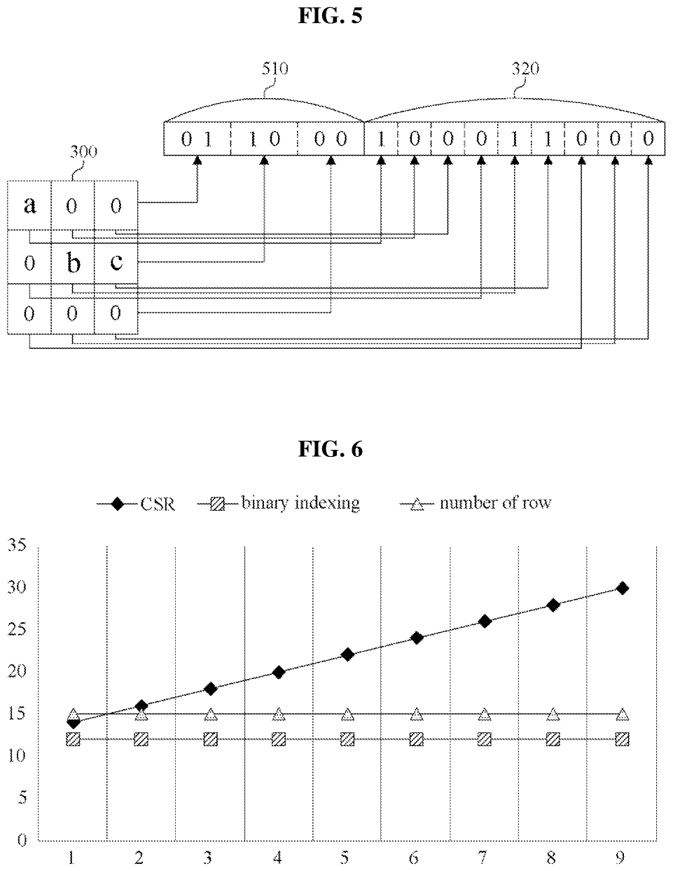

FIG. 4 is a diagram illustrating a method of generating matrix index information according to another embodiment of the present disclosure, and FIG. 5 is a diagram illustrating matrix index information according to the other embodiment of the present disclosure.

Referring to FIG. 4, a device for processing a matrix according to an embodiment of the present disclosure identifies the number of non-zero elements in each row or column of a target matrix (S410) and generates a first bitstring including information on the number of non-zero elements in each row or column of the target matrix (S420). In other words, the first bitstring includes information about how many non-zero elements are present in each row or column of the target matrix, and the first bitstring corresponds to matrix index information.

The first bitstring includes at least one bit corresponding to each row or column of the target matrix. The number of bits corresponding to each of rows or columns is determined in accordance with the size of the target matrix and may be proportionate to the size of the target matrix.

As shown in FIG. 5, when a target matrix 300 is a 3×3 matrix, the maximum number of non-zero elements that may be included in a row or column is 3. Since a first bitstring 510 represents the number of non-zero elements in the form of a binary number, the number of bits corresponding to each row or column of the target matrix 300 may be 2. In FIG. 5, one non-zero element “a” is included in the first row, two non-zero elements “b” and “c” are included in the second row, no non-zero element is included in the third row, and thus a computing device may generate the first bitstring 510 as “011000.”

According to an embodiment, the device for processing a matrix may additionally generate a second bitstring including the position information of non-zero elements in the target matrix. In this case, the matrix index information may include first and second bitstrings. According to an embodiment, the second bitstring may be generated in parallel with the first bitstring or after the first bitstring.

As described above with reference to FIGS. 2 and 3, the second bitstring may include bits corresponding to the positions of elements in a target matrix, and in the second bitstring, a bit value corresponding to the positions of zero elements and a bit value corresponding to the positions of the non-zero elements in the target matrix may be different values.

FIG. 6 is a diagram illustrating the size of matrix index information according to the embodiment of the present disclosure, that is, a graph for comparing a size in accordance with the number of non-zero elements with the size of matrix index information generated in accordance with CSR.

In FIG. 6, the X axis represents the number of non-zero elements, and the Y axis represents the size of matrix index information. Also, in FIG. 6, “binary indexing” represents the matrix index information that is generated in accordance with the embodiment of FIG. 2, and “number of row” represents the matrix index information that is generated in accordance with the embodiment of FIG. 4.

As shown in FIG. 6, when the number of non-zero elements increases, the size of matrix index information in accordance with an embodiment (“binary indexing” and “number of row”) of the present disclosure is kept constant, but the size of matrix index information in accordance with CSR linearly increases.

As a result, according to an embodiment of the present disclosure, even when the sparsity of a matrix is reduced, the size of matrix index information can be kept constant, which can reduce memory usage for the matrix index information in an environment in which a matrix with low sparsity is used.

In particular, the sparsity of a weight matrix varies depending on a pruning ratio for an artificial neural network, and the sparsity of the weight matrix decreases with a reduction in the pruning ratio. Also, a sparsity pattern may significantly vary depending on the weight matrix of a pruned model. Even in this environment, an embodiment of the present disclosure can provide the matrix index information with a certain size, and thus it is possible to reduce memory usage.

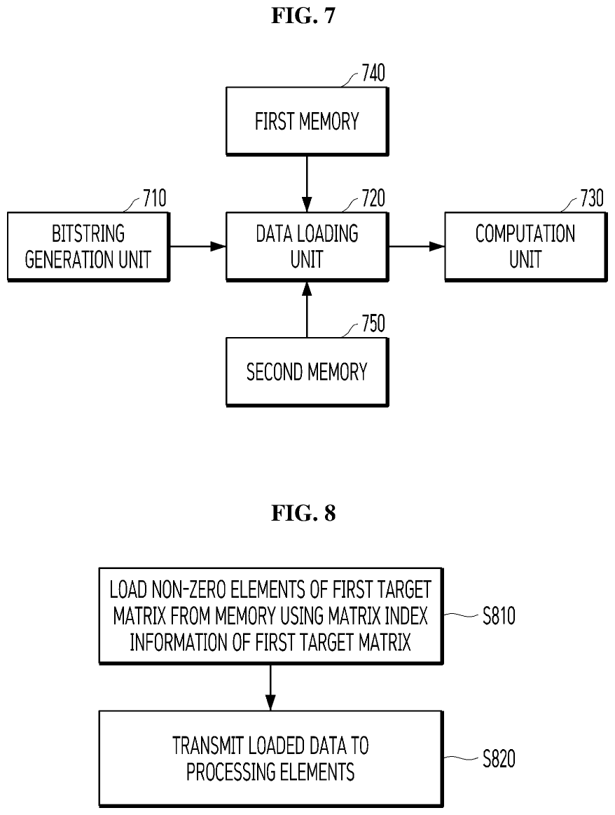

FIG. 7 is a diagram illustrating a device for processing a matrix using matrix index information according to the embodiment of the present disclosure.

Referring to FIG. 7, the device for processing a matrix according to an embodiment of the present disclosure may include a bitstring generation unit 710, a data loading unit 720, and a computation unit 730. According to an embodiment, a memory may be further included.

The bitstring generation unit 710 generates matrix index information. According to an embodiment, the bitstring generation unit 710 may generate a first bitstring including information on the presence or absence of a non-zero element in each row or column of a first target matrix or a first bitstring including the number of non-zero elements in each row or column of the first target matrix. Also, the bitstring generation unit 710 may additionally generate a second bitstring including information on the positions of non-zero elements in the target matrix.

The bitstring generation unit 710 may generate the matrix index information for the first target matrix which is generated during execution or may separately generate the matrix index information for a pruned first target matrix in advance.

The data loading unit 720 loads non-zero elements of the first target matrix from the first memory 740 using the matrix index information. The data loading unit 720 may load the non-zero elements of the first target matrix using the memory address values of non-zero elements stored in the first memory 740. According to an embodiment, the first memory 740 may only store the non-zero elements of the first target matrix or may store all the elements of a row or column including a non-zero element.

As an example, a memory address value assigned to a non-zero element may have a sequential form in accordance with preset rules, and memory address values for non-zero elements of a plurality of target matrices may be assigned in a sequential pattern to correspond to the order of indices assigned to the target matrix. Therefore, the data loading unit 720 can determine the address values of the non-zero elements of the first target matrix using the number of non-zero elements previously loaded from the memory and load the non-zero elements of the first target matrix from the memory using the determined memory address values.

The computation unit 730 performs computation for the first target matrix using the loaded data. For example, the computation unit 730 may perform computation on elements of a second target matrix additionally loaded by the data loading unit 720 and elements of the first target matrix. The elements of the second target matrix may be stored in a second memory 750. According to an embodiment, all the elements of the second target matrix may be stored in the second memory 750 or stored together with the matrix index information in the second memory 750 in the same manner as those of the first target matrix.

The computation unit 730 may include a plurality of processing elements for parallel computation, and the non-zero elements of the first target matrix may be assigned to each of the processing elements. Each processing element may perform computation on the assigned non-zero element of the first target matrix and an element of the second target matrix.

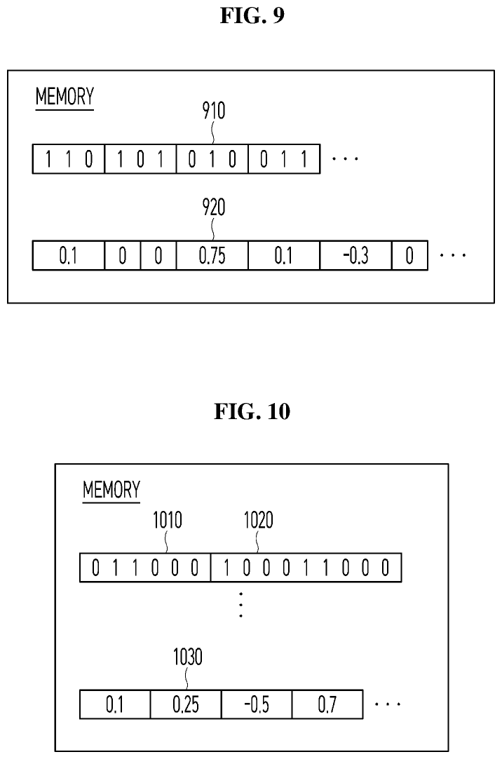

FIG. 8 is a diagram illustrating a method of processing a matrix using matrix index information according to the embodiment of the present disclosure, and FIG. 9 is a diagram showing memory storage data according to the embodiment of the present disclosure.

Referring to FIG. 8, a device for processing a matrix according to an embodiment of the present disclosure loads a non-zero element of a first target matrix from a memory using matrix index information of the first target matrix (S810). Here, the matrix index information includes information on the presence or absence of a non-zero element in each row or column of the first target matrix.

As shown in FIG. 9, the memory may store elements 920 of a row or column including a non-zero element in the first target matrix. In other words, the memory may store not only a non-zero element but also a zero element of a row or column which includes the non-zero element. FIG. 9 shows an embodiment in which matrix index information 910 of four target matrices including the first target matrix is stored in the memory and a bitstring including information on the presence or absence of a non-zero element in each row or column of a target matrix is used as matrix index information. The matrix index information 910 of the first target matrix is 110, and the matrix index information 910 of three other target matrices is 101, 010, and 011. Since the matrix index information 910 of the first target matrix is 110, a non-zero element is included in the first row and the second row of the first target matrix. Accordingly, 0.1, 0, and 0 that are first-row elements of the first target matrix and 0.75, 0.1, and −0.3 that are second-row elements are stored in the memory. Third-row elements of the first target matrix are zero elements and thus are not stored in the memory.

In operation S810, the device for processing a matrix may load elements of a row or column including a non-zero element in the first target matrix. In other words, the device for processing a matrix may load not only a non-zero element but also a zero element of a row or column which includes the non-zero element. In the example of FIG. 9, the device for processing a matrix may load 0.1, 0, 0, 0.75, 0.1, and 0.3 which are first and second-row elements of the first target matrix.

Since the positions of non-zero elements in the first target matrix are not identified only from matrix index information, all the elements of a row or column including a non-zero element are stored in the memory, and a computing device loads all the elements of a row or column including a non-zero element from the memory.

As described above, the device for processing a matrix can check the matrix index information and selectively perform memory access to only a row or column including a non-zero element rather than all the rows or columns of the first target matrix to load elements. Therefore, according to an embodiment of the present disclosure, the number of memory accesses can be reduced.

In operation S810, the device for processing a matrix loads only elements to be multiplied by the non-zero elements of the first target matrix among the elements of the second target matrix from the memory using the matrix index information and transmits the loaded data to the processing elements for performing matrix computation. In other words, the device for processing a matrix does not load any element that is not to be multiplied by the non-zero elements of the first target matrix among the elements of the second target matrix.

According to an embodiment, in operation S810, the device for processing a matrix may load the non-zero elements of the first target matrix from the memory using the matrix index information including number information of non-zero elements in each row or column of the first target matrix. Since the number information of non-zero elements also includes information on the presence or absence of a non-zero element in each row or column of the first target matrix, the device for processing a matrix can use the information on the presence or absence of a non-zero element to load elements of a row or column including a non-zero element in the first target matrix and transmit the loaded data to the processing elements, which is the same as a method of loading non-zero elements.

In other words, the memory stores elements of a row or column including a non-zero element in the first target matrix, and the device for processing a matrix can load the elements of the row or column including the non-zero element in the first target matrix using the number information of non-zero elements.

FIG. 10 is a diagram showing memory storage data according to the other embodiment of the present disclosure.

According to an embodiment, as described in FIG. 8, the device for processing a matrix may load non-zero elements of a first target matrix from a memory using matrix index information that includes not only information on the presence or absence of a non-zero element or the number information of non-zero elements but also position information of non-zero elements in the target matrix.

FIG. 10 shows an embodiment in which number information 1010 of non-zero elements in each row or column of a first target matrix and position information 1020 of non-zero elements in the first target matrix is stored in the memory. When the position information 1020 of non-zero elements is included in matrix index information, the device for processing a matrix can identify the positions of the non-zero elements in the first target matrix, and thus the memory does not store zero elements of the first target matrix but stores non-zero elements 1030 of the first target matrix.

Therefore, the device for processing a matrix can load only the non-zero elements of the first target matrix without loading all the elements of a row or column including a non-zero element in the first target matrix. Since the device for processing a matrix can identify where a loaded non-zero element is positioned in the first target matrix using the position information 1020, it is possible to load only elements of a second target element to be multiplied by the non-zero elements of the first target matrix from the memory.

The above-described technical details may be implemented in the form of program instructions that can be executed by various computing means and recorded on a computer-readable medium. The computer-readable medium may include program instructions, data files, data structures, and the like alone or in combination. The program instructions recorded on the medium may be specially designed and constructed for embodiments or may be known and available to those of ordinary skill in the art of computer software. Examples of the computer-readable recording medium include magnetic media, such as a hard disk, a floppy disk, and magnetic tape, optical media, such as a compact disc (CD)-read only memory (ROM) and a digital versatile disc (DVD), magneto-optical media, such as a floptical disk, and hardware devices specially constructed to store and execute program instructions such as a ROM, a random-access memory (RAM), a flash memory, and the like. Examples of the program instructions include not only machine code generated by a compiler but also high-level language code which is executable by a computer using an interpreter or the like. A hardware device may be configured to operate as one or more software modules to perform operations of embodiments, and vice versa.

Although the present disclosure has been described with reference to particular matters, such as detailed components, limited embodiments, and drawings, these are merely provided to help overall understanding of the present disclosure, and the present disclosure is not limited to the embodiments. Those of ordinary skill in the art can make various alterations and modifications from the description. Therefore, the spirit of the present disclosure should not be limited to the described embodiments, and it should be construed that the following claims and all equivalents or equivalent modifications of the claims fall within the scope of the present disclosure.

What is claimed is:

1. A method of generating matrix index information, comprising:
identifying presence or absence of a non-zero element in each row or column of a target matrix; and
generating a first bitstring including information on the presence or absence of the non-zero element in each row or column of the target matrix.

2. The method of claim 1, wherein the first bitstring includes bits corresponding to each of rows or columns of the target matrix, and
a bit value corresponding to a row or column including the non-zero element and a bit value corresponding to a row or column not including the non-zero element are different in the first bitstring.

3. The method of claim 1, further comprising generating a second bitstring including position information of the non-zero element in the target matrix.

4. The method of claim 3, wherein the second bitstring includes bits corresponding to each of positions of elements in the target matrix, and
a bit value corresponding to positions of zero elements of the target matrix and a bit value corresponding to a position of the non-zero element are different in the second bitstring.

5. A method of generating matrix index information, comprising:
identifying a number of non-zero elements in each row or column of a target matrix; and
generating a first bitstring including information on the number of non-zero elements in each row or column of the target matrix.

6. The method of claim 5, wherein the first bitstring includes at least one bit corresponding to each of rows or columns of the target matrix.

7. The method of claim 5, further comprising generating a second bitstring including position information of the non-zero elements in the target matrix.

8. The method of claim 7, wherein the second bitstring includes bits corresponding to each of positions of elements in the target matrix, and
a bit value corresponding to positions of zero elements of the target matrix and a bit value corresponding to positions of the non-zero elements are different in the first bitstring.

9. A method of processing a matrix using matrix index information, the method comprising:
loading a non-zero element of a first target matrix from a memory using matrix index information of the first target matrix; and
transmitting loaded data to processing elements,
wherein the matrix index information includes information on presence or absence of the non-zero element in each row or column of the first target matrix.

10. The method of claim 9, wherein the memory stores elements of a row or column including the non-zero element in the first target matrix, and
the loading of the non-zero element of the first target matrix from the memory comprises loading the elements of the row or column including the non-zero element in the first target matrix.

11. The method of claim 9, wherein the loading of the non-zero element from the memory comprises loading only elements to be multiplied by the non-zero element of the first target matrix among elements of a second target matrix from the memory using the matrix index information.

12. The method of claim 9, wherein the matrix index information further includes position information of the non-zero element in the first target matrix, and
the memory does not store zero elements of the first target matrix but stores the non-zero element.

13. A method of processing a matrix using matrix index information, comprising:
loading non-zero elements of a first target matrix from a memory using matrix index information of the first target matrix; and
transmitting loaded data to processing elements,
wherein the matrix index information includes number information of non-zero elements in each row or column of the first target matrix.

14. The method of claim 13, wherein the memory stores elements of a row or column including the non-zero elements in the first target matrix, and the loading of the non-zero elements of the first target matrix from the memory comprises loading the elements of the row or column including the non-zero elements in the first target matrix.

15. The method of claim 14, wherein the loading of the non-zero elements from the memory comprises loading only elements to be multiplied by the non-zero elements of the first target matrix among elements of a second target matrix from the memory using the matrix index information.

16. The method of claim 14, wherein the matrix index information further includes position information of the non-zero elements in the first target matrix, and
the memory does not store zero elements of the first target matrix but stores the non-zero elements.
